(19) United States
(12) Patent Application Publication
(10) Pub. No.: US 2021/0301105 A1
(43) Pub. Date: Sep. 30, 2021

(54) LINING MATERIAL OF NONMETAL FLEXIBLE COMPOSITE PIPE AND PREPARATION METHOD THEREOF

(71) Applicants: China Merchants Marine and Offshore Research Institute Co., LTD., Guangdong (CN); China University of Petroleum-Beijing, Beijing (CN)

(72) Inventors: Lixin XU, Guangdong (CN); Xiaoyu MENG, Beijing (CN); Hui CAO, Beijing (CN); Chuanbo CONG, Beijing (CN); Qinjing GUO, Guangdong (CN); Qiong ZHOU, Beijing (CN); Jiancheng LIU, Guangdong (CN)

(73) Assignees: China Merchants Marine and Offshore Research Institute Co., LTD., Guangdong (CN); China University of Petroleum-Beijing, Beijing (CN)

(21) Appl. No.: 17/265,522

(22) PCT Filed: May 18, 2020
(86) PCT No.: PCT/CN2020/090857

§ 371 Date: Feb. 3, 2021

(30) Foreign Application Priority Data
May 25, 2019 (CN) 201910444766.1

(51) Int. Cl. C08K 9/04; C08K 3/04; C08K 3/34; C08K 3/36; C08K 9/02

(52) U.S. Cl. CPC C08K 9/04; C08K 3/041; C08K 3/042; C08K 2003/3009; C08K 3/36; C08K 9/02; C08K 3/046; C08K 3/346

(57) ABSTRACT

The present invention relates to a lining material of a nonmetal flexible composite pipe and a preparation method. The lining material consists of the following components in the following proportions: 89.5-99.4 wt % of a polymer matrix, 0.5-10 wt % of inorganic particles and 0.1-0.5 wt % of an antioxidant. The preparation method comprises the following steps: (1) preparation of raw materials: raw materials are weighed in a mass ratio for later use; (2) compounding and plasticizing: inorganic particles, a polymer matrix and an antioxidant are added into a twin-screw extruder or a mixer at an extruding or mixing temperature of 190-360° C., and extruded and cooled for later use; and (3) pelleting: the materials after the compounding and plasticizing obtained in the step (2) are pelleted in a pelletizer to obtain the lining material of a nonmetal flexible composite pipe.

### BACKGROUND

### Technical Field

The present invention relates to the field of industrial application of polymer materials, and in particular to a lining material of a nonmetal flexible composite pipe and a preparation method thereof.

### Description of Related Art

An offshore oil and gas pipeline, as the “lifeline” of an offshore oil and gas production system, plays a crucial role in the development and output of offshore oil and gas resources. However, the joint action of high temperature, high pressure, hydrogen sulfide, carbon dioxide and the like in the pipeline easily causes degradation of the material properties. At present, transportation pipelines for underground and marine engineering are mostly made of steel and are corroded from environmental conditions such as transportation media, soil, microorganisms and external atmosphere because they are buried underground all the year round. Meanwhile, with the increase of the transportation time, constant corrosion of the transportation media and gradual thinning of the pipeline wall, in case that the transportation pressure remains unchanged, the pipeline leaks frequently and even bursts. Further, the leaking pipelines are almost all buried under the ground or sea, and the span length is very long, from one kilometer to dozens of kilometers, and even hundreds of kilometers, so that it is time-consuming and laborious to find leaking points and conduct digging and repairing, and the cost is high and it is difficult to repair the entire pipeline. Therefore, there is a need for a material that has excellent temperature resistance, mechanical properties, corrosion resistance and barrier properties.

A single material can rarely meet the requirements for various properties, and a composite material is an effective means of enhancing overall material performance. A Chinese patent document (Application No.: 201410591918.8) discloses a composite wire flexible pipe, in which a complex liquid of reinforced nanoparticles and a binder is used; and the reinforced particles include one or several of nano silicon dioxide, nano aluminum oxide, nano calcium carbonate, carbon nano tube and nano graphite. The complex liquid is wrapped around reinforcing fibers of a flexible pipe and plays a role of bonding enhancement. This is significantly different from the preparation of a lining material. This composite liquid does not need to consider the barrier properties of the medium; in addition, there is no need to consider the dispersion of the particles in the polymer matrix, which is the key to making the nanoparticles work.

Therefore, the present invention provides a lining material of a nonmetal flexible composite pipe for use in a marine riser and a submarine pipeline and a preparation method thereof, in which through surface modification, nanoparticles are uniformly dispersed in a polymer matrix, thereby improving the corrosion resistance, barrier properties, mechanical properties and temperature resistance of the material.

### SUMMARY

The technical problem to be solved by the present invention is to provide a lining material of a nonmetal flexible composite pipe, which enables uniform dispersion and improvement in corrosion resistance, barrier properties, mechanical properties and temperature resistance.

To solve the above-mentioned problem, the technical solution adopted by the present invention is as follows: the lining material of a nonmetal flexible composite pipe is a modified thermoplastic polymer composite material, consisting of the following components in the following proportions:

89.5-99.4 wt % of a polymer matrix;

0.5-10 wt % of inorganic particles; and

0.1-0.5 wt % of an antioxidant.

In the above-mentioned technical solution, the polymer matrix is mixed with the inorganic particles and the antioxidant such that the inorganic particles are uniformly dispersed in the polymer matrix; and through synergy of the components, the corrosion resistance, barrier properties, mechanical properties and temperature resistance of the lining material of a nonmetal flexible composite pipe can be improved.

As a preferred technical solution of the present invention, the polymer matrix is one of polyethylene (PE), polyamide (PA), polybutylene terephthalate (PBT), polyketone (POK), polyphenylene sulfide (PPS), polyether ether ketone (PEEK), polyvinylidene fluoride (PVDF), thermoplastic polyurethane (TPU), fusible polytetrafluoroethylene (PFA) and polyphenylene oxide (PPO), or a mixture thereof.

As a preferred technical solution of the present invention, the inorganic particles refer to one of nano silicon dioxide (SiO₂), carbon nano tube (CNT), carbon nanofiber aggregate (CNFA), graphene oxide (GO), nano montmorillonite (MMT), graphite (Gr) and molybdenum disulfide (MoS₂), or a mixture thereof.

As a preferred technical solution of the present invention, the inorganic particles are subjected to surface modification using a surface modifier, wherein the surface modifier is one of a silane coupling agent, a quaternary ammonium salt surfactant, ethylenediamine, polyethyleneimine and a polyurethane prepolymer; and the mass ratio of the surface modifier to the inorganic particles is 1:100 to 1:10. After surface modification, the inorganic particles achieve better dispersibility in the polymer matrix, thereby improving the corrosion resistance, barrier properties, mechanical properties and temperature resistance of the lining material of a nonmetal flexible composite pipe.

As a preferred technical solution of the present invention, the particle size of the inorganic particles is 200-400 meshes.

The technical problem to be further solved by the present invention is to provide a method of preparing a lining material of a nonmetal flexible composite pipe, which enables uniform dispersion and improvement in corrosion resistance, barrier properties, mechanical properties and temperature resistance.

To solve the above-mentioned problem, the technical solution adopted by the present invention is as follows: the method of preparing a lining material of a nonmetal flexible composite pipe comprises the following specific steps:

(1) preparation of raw materials: raw materials are weighted in a mass ratio for later use, the raw materials comprising 89.5-99.4 wt % of a polymer matrix, 0.5-10 wt % of inorganic particles and 0.1-0.5 wt % of an antioxidant;

(2) compounding and plasticizing: the inorganic particles and the polymer matrix as well as the antioxidant are added into a twin-screw extruder or a mixer at an extruding or mixing temperature of 190-360° C., and extruded and cooled for later use; and

(3) pelleting: the materials after the compounding and plasticizing obtained in the step (2) are pelleted in a pelletizer to obtain the lining material of a nonmetal flexible composite pipe.

The lining material of a nonmetal flexible composite pipe is used in a marine riser and/or a submarine pipeline.

Compared with the prior art, the present invention has the following beneficial effects:

(1) the modification of the inorganic particles enables the inorganic particles to be dispersed more uniformly in the polymer matrix;

(2) after the compound modification, the lining material of a nonmetal flexible composite pipe is remarkably improved in terms of corrosion resistance, barrier properties, mechanical properties and temperature resistance; and

(3) the lining material of a nonmetal flexible composite pipe has simple composition but better performance, so that the cost is lowered; and meanwhile, the preparation method is simple, controllable and suitable for a wide range of applications.

### DESCRIPTION OF THE EMBODIMENTS

### Example 1

The lining material of a nonmetal flexible composite pipe was prepared by the following specific steps:

(1) preparation of raw materials: raw materials were weighted in a mass ratio for later use, the raw materials including 89.5 wt % of a polymer matrix, 5 wt % of nano SiO₂ and 5 wt % of MMT, and 0.5 wt % of an antioxidant;

(2) compounding and plasticizing: the nano SiO₂ and the MMT and the polymer matrix as well as the antioxidant in the step (1) were added into a twin-screw extruder at an extruding temperature of 190-230° C., and extruded and cooled for later use; and

(3) pelleting: the materials after the compounding and plasticizing obtained in the step (2) were pelleted in a pelletizer at a pelleting temperature of 200° C. to obtain the lining material of a nonmetal flexible composite pipe.

### Example 2

The lining material of a nonmetal flexible composite pipe was prepared by the following specific steps:

(1) preparation of raw materials: raw materials were weighted in a mass ratio for later use, the raw materials including 98.8 wt % of POK, 0.5 wt % of CNT and 0.5 wt % of MoS₂, and 0.2 wt % of an antioxidant;

(2) surface modification of inorganic particles: CNT was subjected to surface modification, wherein a surface modifier was a polyurethane prepolymer, and the mass ratio of the polyurethane prepolymer to the carbon nano tube was 1:10;

(3) compounding and plasticizing: the CNT subjected to surface modification in the step (2) and MoS₂ and the polymer matrix as well as the antioxidant were added into a twin-screw extruder at an extruding temperature of 190-230° C., and extruded and cooled for later use; and

(4) pelleting: the materials after the compounding and plasticizing obtained in the step (3) were pelleted in a pelletizer at a pelleting temperature of 200° C. to obtain the lining material of a nonmetal flexible composite pipe.

### Example 3

The lining material of a nonmetal flexible composite pipe was prepared by the following specific steps:

(1) preparation of raw materials: raw materials were weighted in a mass ratio for later use, the raw materials including 89.8 wt % of PVDF, 3.0 wt % of nano montmorillonite and 0.2 wt % of an antioxidant;

(2) surface modification of inorganic particles: the nano montmorillonite was subjected to surface modification, wherein a surface modifier was a quaternary ammonium salt surfactant, and the mass ratio of the quaternary ammonium salt surfactant to the nano montmorillonite was 1:40;

(3) compounding and plasticizing: the nano montmorillonite subjected to surface modification in the step (2) and the polymer matrix as well as the antioxidant were added into a mixer at a mixing temperature of 220° C., and extruded and cooled for later use; and

(4) pelleting: the materials after the compounding and plasticizing obtained in the step (3) were pelleted in a pelletizer at a pelleting temperature of 200° C. to obtain the lining material of a nonmetal flexible composite pipe.

### Example 4

The lining material of a nonmetal flexible composite pipe was prepared by the following specific steps:

(1) preparation of raw materials: raw materials were weighted in a mass ratio for later use, the raw materials including 99.4 wt % of PFA, 0.5 wt % of GO and 0.1 wt % of an antioxidant;

(2) surface modification of inorganic particles: GO was subjected to surface modification, wherein a surface modifier was polyethyleneimine, and the mass ratio of the polyethyleneimine to the graphene oxide was 1:100;

(3) compounding and plasticizing: the GO subjected to surface modification in the step (2) and the polymer matrix as well as the antioxidant were added into a twin-screw extruder at an extruding temperature of 280-350° C., and extruded and cooled for later use; and

(4) pelleting: the materials after the compounding and plasticizing obtained in the step (3) were pelleted in a pelletizer at a pelleting temperature of 200° C. to obtain the lining material of a nonmetal flexible composite pipe.

### Example 5

The lining material of a nonmetal flexible composite pipe was prepared by the following specific steps:

(1) preparation of raw materials: raw materials were weighted in a mass ratio for later use, the raw materials including 89.8 wt % of PEEK, 2 wt % of nano CNF and 1 wt % of graphite, and 0.3 wt % of an antioxidant;

(2) compounding and plasticizing: the PEEK and the nano CNF and the graphite as well as the antioxidant in the step (1) were added into a twin-screw extruder at an extruding temperature of 310-360° C., and extruded and cooled for later use; and

(3) pelleting: the materials after the compounding and plasticizing obtained in the step (2) were pelleted in a pelletizer at a pelleting temperature of 200° C. to obtain the lining material of a nonmetal flexible composite pipe.

The test results of the properties of the above-mentioned five examples and the corresponding polymer matrices are shown in Table 1 below:

TABLE 1
Comparison of properties of five examples and corresponding polymer matrices

| | | PA11 | | POK | | PVDF | | PFA | | PEEK |
|---|---|---|---|---|---|---|---|---|---|---|
| | Example 1 | matrix | Example 2 | matrix | Example 3 | matrix | Example 4 | matrix | Example 5 | matrix |
| Vicat | 164 | 160 | 196 | 190 | 142 | 139 | 135 | 130 | 218 | 214 |
| softening | | | | | | | | | | |
| temperature/° C. | | | | | | | | | | |
| (B50) | | | | | | | | | | |
| Tensile | 60 | 50 | 70 | 55 | 57 | 51 | 35 | 28 | 95 | 83 |
| strength/ | | | | | | | | | | |
| MPa | | | | | | | | | | |
| Elongation | 270 | 350 | 280 | 300 | 300 | 400 | 265 | 300 | 38 | 43 |
| at break/% | | | | | | | | | | |
| Change | −9.5 | −13.1 | −4.1 | −5.1 | −12.5 | −16.4 | −4.5 | −8.1 | −1.9 | −2.3 |
| rate of | | | | | | | | | | |
| tensile | | | | | | | | | | |
| strength/% | | | | | | | | | | |
| Change | +3.2 | +4.3 | +2.0 | +3.2 | +5.0 | +7.8 | +2.2 | +3.7 | +1.8 | +2.1 |
| rate of | | | | | | | | | | |
| mass/% | | | | | | | | | | |
| O₂ | 0.50 | 0.80 | 0.15 | 0.20 | 0.10 | 0.20 | 0.07 | 0.10 | 0.03 | 0.05 |
| permeability/ | | | | | | | | | | |
| cc · mm · m⁻² · d⁻¹atm⁻¹ | | | | | | | | | | |

Notes:
In the Table, the change rate of tensile strength and the change rate of mass are used to evaluate the corrosion resistance of the material, and in the data of change rates, “+” represents increase of the value, and “−” represents decrease of the value. In the Example 1, corrosion conditions 1 are used to evaluate the corrosion resistance; in the Examples 2 and 3, corrosion conditions 2 are used to evaluate the corrosion resistance; and in the Examples 4 and 5, corrosion conditions 3 are used to evaluate the corrosion resistance.
Corrosion conditions 1: temperature of 80° C., 60 vol % of a liquid phase, 40 vol % of a gas phase, the liquid phase containing 50 vol % of mineralized water and 50 vol % of crude oil, total pressure of 30 MPa, including H₂S partial pressure of 0.9 MPa, CO₂ partial pressure of 1.0 MPa and the rest being N₂, and experimental time of 7 days;
corrosion conditions 2: temperature of 120° C., 60 vol % of a liquid phase, 40 vol % of a gas phase, the liquid phase containing 50 vol % of mineralized water and 50 vol % of crude oil, total pressure of 30 MPa, including H₂S partial pressure of 0.9 MPa, CO₂ partial pressure of 1.0 MPa and the rest being N₂, and experimental time of 7 days; and
corrosion conditions 3: temperature of 150° C., 60 vol % of a liquid phase, 40 vol % of a gas phase, the liquid phase containing 50 vol % of mineralized water and 50 vol % of crude oil, total pressure of 30 MPa, including H₂S partial pressure of 0.9 MPa, CO₂ partial pressure of 1.0 MPa and the rest being N₂, and experimental time of 7 days.

As seen from the test results of the properties, the modification of the inorganic particles enables the inorganic particles to be dispersed more uniformly in the polymer matrix; and after the compound modification, the lining material of a nonmetal flexible composite pipe is remarkably improved in terms of corrosion resistance, barrier properties, mechanical properties and temperature resistance.

Further, it should be noted that only several specific examples of the present invention are listed above. Apparently, the present invention is not limited to the above-mentioned examples, and many variations are possible. All variations that can be directly derived or envisioned by those of ordinary skill in the art from the disclosure of the present invention should be considered to be within the scope of the present invention.

1. A lining material of a nonmetal flexible composite pipe, which is a modified thermoplastic polymer composite material, consisting of the following components in the following proportions:
89.5-99.4 wt % of a polymer matrix;
0.5-10 wt % of inorganic particles; and
0.1-0.5 wt % of an antioxidant.

2. The lining material of the nonmetal flexible composite pipe according to claim 1, wherein the polymer matrix is one of polyethylene, polyamide, polybutylene terephthalate, polyketone, polyphenylene sulfide, polyether ether ketone, polyvinylidene fluoride, fusible polytetrafluoroethylene and polyphenylene oxide, or a mixture thereof.

3. The lining material of the nonmetal flexible composite pipe according to claim 1, wherein the inorganic particles refer to one of nano silicon dioxide, carbon nano tube, carbon nanofiber aggregate, graphene oxide, nano montmorillonite, graphite and molybdenum disulfide, or a mixture thereof.

4. The lining material of the nonmetal flexible composite pipe according to claim 3, wherein the inorganic particles are subjected to surface modification using a surface modifier, wherein the surface modifier is one of a silane coupling agent, a quaternary ammonium salt surfactant, ethylenediamine, polyethyleneimine and a polyurethane prepolymer; and a mass ratio of the surface modifier to the inorganic particles is 1:100 to 1:10.

5. The lining material of the nonmetal flexible composite pipe according to claim 3, wherein a particle size of the inorganic particles is 200-400 meshes.

6. A method of preparing the lining material of the nonmetal flexible composite pipe according to claim 1, comprising the following specific steps:
step 1: preparation of raw materials: raw materials are weighted in a mass ratio for later use, the raw materials comprising 89.5-99.4 wt % of the polymer matrix, 0.5-10 wt % of the inorganic particles and 0.1-0.5 wt % of the antioxidant;
step 2: compounding and plasticizing: the inorganic particles and the polymer matrix as well as the antioxidant are added into a twin-screw extruder or a mixer at an extruding or mixing temperature of 190-360° C., and extruded and cooled for later use; and
step 3: pelleting: the materials after the compounding and plasticizing obtained in the step 2 are pelleted in a pelletizer to obtain the lining material of the nonmetal flexible composite pipe.

7. Use of the lining material of the nonmetal flexible composite pipe according to claim 1, the lining material of the nonmetal flexible composite pipe is used in a marine riser and/or a submarine pipeline.

8. A method of preparing the lining material of the nonmetal flexible composite pipe according to claim 2, comprising the following specific steps:
step 1: preparation of raw materials: raw materials are weighted in a mass ratio for later use, the raw materials comprising 89.5-99.4 wt % of the polymer matrix, 0.5-10 wt % of the inorganic particles and 0.1-0.5 wt % of the antioxidant;
step 2: compounding and plasticizing: the inorganic particles and the polymer matrix as well as the antioxidant are added into a twin-screw extruder or a mixer at an extruding or mixing temperature of 190-360° C., and extruded and cooled for later use; and
step 3: pelleting: the materials after the compounding and plasticizing obtained in the step 2 are pelleted in a pelletizer to obtain the lining material of the nonmetal flexible composite pipe.

9. A method of preparing the lining material of the nonmetal flexible composite pipe according to claim 3, comprising the following specific steps:
step 1: preparation of raw materials: raw materials are weighted in a mass ratio for later use, the raw materials comprising 89.5-99.4 wt % of the polymer matrix, 0.5-10 wt % of the inorganic particles and 0.1-0.5 wt % of the antioxidant;
step 2: compounding and plasticizing: the inorganic particles and the polymer matrix as well as the antioxidant are added into a twin-screw extruder or a mixer at an extruding or mixing temperature of 190-360° C., and extruded and cooled for later use; and
step 3: pelleting: the materials after the compounding and plasticizing obtained in the step 2 are pelleted in a pelletizer to obtain the lining material of the nonmetal flexible composite pipe.

10. A method of preparing the lining material of the nonmetal flexible composite pipe according to claim 4, comprising the following specific steps:
step 1: preparation of raw materials: raw materials are weighted in a mass ratio for later use, the raw materials comprising 89.5-99.4 wt % of the polymer matrix, 0.5-10 wt % of the inorganic particles and 0.1-0.5 wt % of the antioxidant;
step 2: compounding and plasticizing: the inorganic particles and the polymer matrix as well as the antioxidant are added into a twin-screw extruder or a mixer at an extruding or mixing temperature of 190-360° C., and extruded and cooled for later use; and
step 3: pelleting: the materials after the compounding and plasticizing obtained in the step 2 are pelleted in a pelletizer to obtain the lining material of the nonmetal flexible composite pipe.

11. A method of preparing the lining material of the nonmetal flexible composite pipe according to claim 5, comprising the following specific steps:
step 1: preparation of raw materials: raw materials are weighted in a mass ratio for later use, the raw materials comprising 89.5-99.4 wt % of the polymer matrix, 0.5-10 wt % of the inorganic particles and 0.1-0.5 wt % of the antioxidant;
step 2: compounding and plasticizing: the inorganic particles and the polymer matrix as well as the antioxidant are added into a twin-screw extruder or a mixer at an extruding or mixing temperature of 190-360° C., and extruded and cooled for later use; and
step 3: pelleting: the materials after the compounding and plasticizing obtained in the step 2 are pelleted in a pelletizer to obtain the lining material of the nonmetal flexible composite pipe.

12. Use of the lining material of the nonmetal flexible composite pipe according to claim 2, the lining material of the nonmetal flexible composite pipe is used in a marine riser and/or a submarine pipeline.

13. Use of the lining material of the nonmetal flexible composite pipe according to claim 3, the lining material of the nonmetal flexible composite pipe is used in a marine riser and/or a submarine pipeline.

14. Use of the lining material of the nonmetal flexible composite pipe according to claim 4, the lining material of the nonmetal flexible composite pipe is used in a marine riser and/or a submarine pipeline.

15. Use of the lining material of the nonmetal flexible composite pipe according to claim 5, the lining material of the nonmetal flexible composite pipe is used in a marine riser and/or a submarine pipeline.

16. Use of the lining material of the nonmetal flexible composite pipe according to claim 6, the lining material of the nonmetal flexible composite pipe is used in a marine riser and/or a submarine pipeline.
